(19) United States
(12) Patent Application Publication
(10) Pub. No.: US 2010/0168282 A1
(43) Pub. Date: Jul. 1, 2010

(54) DISPERSION COMPRISING INORGANIC PARTICLES, WATER, AND AT LEAST ONE POLYMERIC ADDITIVE

(75) Inventors: Patrick Becker, Muehltal (DE); Gerold Schmitt, Aschaffenburg (DE); Zhengfeng Zhang, Shanghai (CN); Lina Xue, Shanghai (CN)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/601,283

(22) PCT Filed: Feb. 4, 2008
(86) PCT No.: PCT/EP2008/051325

§ 371 Date: Nov. 23, 2009

(30) Foreign Application Priority Data
May 21, 2007 (DE) 10 2007 023 813.6

(51) Int. Cl. C04B 24/26

(52) U.S. Cl. 524/5; 524/555

(57) ABSTRACT

The present invention relates to a dispersion comprising inorganic particles, water and at least one water-soluble polymer, wherein the water-soluble polymer comprises repeating units derived from monomers having at least one quaternary ammonium group, repeating units derived from monomers having at least one carboxy group and repeating units derived from ester monomers which contain polyalkoxyalkylene groups and have a number average molecular weight in the range from 3000 g/mol to 10 000 g/mol.

The present dispersion can, in particular, be used for producing concrete and can be processed over a very long period of time.

The present invention relates to a dispersion comprising inorganic particles, water and at least one polymeric additive. The present invention also describes a process for producing concrete and the use of polymers for increasing the processing time of dispersions for producing concrete.

Polymeric additives for improving the processability of dispersions comprising inorganic particles have been known for a relatively long time. They enable, in particular, the water content to be reduced while maintaining a very high flowability.

Water-reducing compositions are widely used in cement-like compositions such as concrete in order to reduce the water content (and improve the strength) while maintaining the flow behaviour or the “slump” (so that the composition can flow easily, for example around a complicated shuttering). Typical water-reducing agents are “superplasticizers” such as β-naphthalene-sulphonate-formaldehyde (“BSN”) condensates and various materials based on polycarboxylates. One of the problems which the water-reducing agents, in particular the abovementioned polycarboxylates, can present is the introduction of excessive volumes of air into the cement-like compositions. While the presence of some air is harmless and even advantageous, an excessive introduction of air leads to reduced strength. Improved polycarboxylates are described, inter alia, in the document DE 44 20 444. These polymers comprise, in particular, carboxylic acid groups and groups which are derived from polyoxyalkylenes. However, polymers which additionally comprise cationic groups are not described in this document.

Furthermore, the document WO 01/58579 describes dispersions of the abovementioned type which comprise polymers having cationic groups and anionic groups. Furthermore, these polymers have repeating units comprising polyoxyalkylene groups. The cationic groups here can be formed by monomers containing amino groups at a low pH. In addition, a wide range is given for the molar mass of the monomers comprising polyoxyalkylene groups which are used for preparing the polymers. Preference for monomers which contain polyoxyalkylene groups and have a molar mass of at least 3000 g/mol is not indicated.

The additives described in the abovementioned documents display a good property spectrum. A great problem which occurs particularly in the case of concrete dispersions is the processing time of the dispersion. The flowability frequently decreases after only a short time, so that the dispersion has to be processed within a very short time. However, this represents a great problem in the case of very large quantities of concrete. The abovementioned documents do not, however, give any pointers to improving the processing time.

In view of the prior art, it is an object of the present invention to provide a dispersion of the abovementioned generic type which has a particularly good property profile. In particular, the dispersion should be able to be processed over a very long period of time. In this context, a flowability (slump) of the dispersion which remains constant over a long period of time is a particular property to be improved.

Furthermore, the cement-like compositions should have a high slump but without excessive introduction of air. In addition, it was therefore an object of the present invention to provide dispersions for producing concrete which, after curing, lead to concrete having excellent mechanical properties.

These objects and further objects which have not been explicitly mentioned but can readily be derived or concluded from the relationships discussed here in an introductory fashion are achieved by a dispersion having all features of claim 1. Advantageous modifications of the dispersion of the invention are protected in subordinate claims. As regards the process for producing concrete and the use of water-soluble polymers for increasing the processing time, claims 21 and 22 provide a solution to the problem.

The present invention accordingly provides a dispersion comprising inorganic particles, water and at least one water-soluble polymer, which is characterized in that the water-soluble polymer comprises repeating units derived from monomers having at least one quaternary ammonium group, repeating units derived from monomers having at least one carboxy group and repeating units derived from ester monomers which contain polyalkoxyalkylene groups and have a number average molecular weight in the range from 3000 g/mol to 10 000 g/mol.

This makes it possible, in an unforeseeable manner, to provide a dispersion of the abovementioned generic type which has a particularly good property profile. The dispersion can surprisingly be processed over a very long period of time. Preferred dispersions are characterized in that, in particular, the flowability (slump) of the dispersion remains relatively constant over a long period of time.

Furthermore, the cement-like compositions display a high slump but without excessive introduction of air. In addition, the measures according to the invention surprisingly make it possible to provide dispersions for producing concrete which lead, after curing, to concrete having excellent mechanical properties.

The dispersions of the invention comprise inorganic particles. These particles are widely known to those skilled in the art and comprise, in particular, known constituents for producing cement-like compositions, for example constituents of cement, sand, gravel and slag residues which are used for producing concrete.

A dispersion according to the present invention preferably comprises from 70% by weight to 98.99% by weight, preferably from 80 to 95% by weight, of inorganic particles.

The water used in the dispersions can be of a customary quality, so that process water is satisfactory for most purposes. However, drinking water can also be used for producing the dispersion. The proportion of water can be selected within a wide range, with preferred dispersions comprising from 1% by weight to 30% by weight, preferably from 5 to 15% by weight, of water.

A dispersion according to the invention comprises, as significant constituent, at least one water-soluble polymer comprising repeating units derived from monomers having at least one quaternary ammonium group, repeating units derived from monomers having at least one carboxy group and repeating units derived from ester monomers which contain polyalkoxyalkylene groups and have a number average molecular weight in the range from 3000 g/mol to 10 000 g/mol.

The term repeating unit is widely known to those skilled in the art. The present water-soluble polymers can preferably be obtained via free-radical polymerization of the monomers. Here, carbon-carbon double bonds are opened to form covalent bonds. The repeating units are obtained in this way from the monomers used for the preparation.

Monomers having a quaternary ammonium group are widely known to those skilled in the art. Such monomers are generally able to be polymerized by a free radical mechanism and have a carbon-carbon double bond. For the present purposes, a quaternary ammonium group is a group of the formula —R^{a}—NR^{b}R^{c}R^{d+}, where the radicals R^{a}, R^{b}, R^{c} and R^{d} are each, independently of one another, a radical which has from 1 to 30 carbon atoms and may be linear or branched. These radicals can be aliphatic or aromatic. The radical R^{a} is preferably an alkylene group having from 1 to 10, preferably from 2 to 6, carbon atoms and the radicals R^{b}, R^{c} and R^{d} are preferably each, independently of one another, an alkyl group having from 1 to 6, particularly preferably from 1 to 4, carbon atoms.

Preferred alkyl radicals include, in particular, the methyl, ethyl, propyl, butyl, pentyl and hexyl groups. Alkenyl radicals having from 1 to 10 carbon atoms include, in particular, the methylene, ethylene, propylene, butylene, pentylene and hexylene groups. The alkyl and alkylene radicals can comprise heteroatoms, for example oxygen, nitrogen or sulphur atoms.

The monomer having a quaternary ammonium group is preferably a compound of the formula (I)

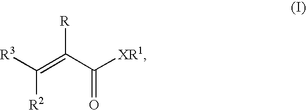

where R is hydrogen or methyl, X is oxygen or a group of the formula —NR*, where R* is hydrogen or an alkyl group having from 1 to 4 carbon atoms, R¹ is a group which has from 4 to 30, preferably from 5 to 15, carbon atoms and has at least one quaternary ammonium group, R² and R³ are each, independently of one another, hydrogen or a group of the formula —COOR′, where R′ is hydrogen or a group which has from 4 to 30, preferably from 5 to 15, carbon atoms and has at least one quaternary ammonium group.

The expression “a group having from 5 to 30 carbon atoms” characterizes radicals of organic compounds which have from 5 to 30 carbon atoms. It encompasses both aromatic and heteroaromatic groups and also aliphatic and heteroaliphatic groups such as alkyl, cycloalkyl, alkoxy, cycloalkoxy, cycloalkylthio and alkenyl groups. The groups mentioned can be branched or unbranched.

For the purposes of the invention, aromatic groups are radicals of monocyclic or polycyclic aromatic compounds which preferably have from 6 to 20, in particular from 6 to 12, carbon atoms.

Heteroaromatic groups are aryl radicals in which at least one CH group has been replaced by N and/or at least two adjacent CH groups have been replaced by S, NH or O.

Aromatic and heteroaromatic groups which are preferred for the purposes of the invention are derived from benzene, naphthalene, biphenyl, diphenyl ether, diphenylmethane, diphenyldimethylmethane, bisphenone, diphenyl sulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxa-diazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzo-oxadiazole, benzopyridine, benzopyrazine, benzo-pyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may, if desired, also be substituted.

Preferred alkyl groups include the methyl, ethyl, propyl, isopropyl, 1-butyl, 2-butyl, 2-methylpropyl, tert-butyl, pentyl, 2-methylbutyl, 1,1-dimethylpropyl, hexyl, heptyl, octyl, 1,1,3,3-tetramethylbutyl, nonyl, 1-decyl, 2-decyl, undecyl, dodecyl, pentadecyl and eicosyl groups.

Preferred cycloalkyl groups include the cyclopropyl, cyclobutyl, cyclopentyl, cyclohexyl, cycloheptyl and cyclooctyl groups, which may, if desired, be substituted by branched or unbranched alkyl groups.

Preferred alkenyl groups include the vinyl, allyl, 2-methyl-2-propenyl, 2-butenyl, 2-pentenyl, 2-decenyl and 2-eicosenyl groups.

Preferred heteroaliphatic groups include the abovementioned preferred alkyl and cycloalkyl radicals in which at least one carbon unit has been replaced by O, S or an NR* or NR*R** group, where R* and R** are each, independently of one another, an alkyl group having from 1 to 6 carbon atoms, an alkoxy group having from 1 to 6 carbon atoms or an aryl group.

The monomer having a quaternary ammonium group is preferably a (meth)acrylate or a (meth)acrylamide. The expression (meth)acrylates encompasses methacrylates and acrylates and also mixtures of the two.

The quaternary ammonium group has a positive charge. As counterion, the monomer having a quaternary ammonium group can in general have any anion, with preference being given to halide, sulphate, sulphonate ions. The monomer preferably has a high solubility in water, so that the choice of anion can be restricted by this.

Examples of monomers having a quaternary ammonium group encompass N,N,N-trimethyl-N-(2-methacryloxyethyl)ammonium chloride [CH₂═C(CH₃) COO—CH₂CH₂—N⁺ (CH₃)₃Cl⁻], N-(2-methacryloyloxy)ethyl-N,N,N-trimethylammonium methylsulphate [CH₂═C(CH₃) COO—CH₂CH₂—N⁺ (CH₃)₃CH₃SO₄], N-(2-methacryloyloxy)ethyl-N,N-dimethyl-N-ethylammonium ethylsulphate [CH₂═C(CH₃) COO—CH₂CH₂—N⁺ (CH₃)₂ (C₂H₅) C₂H₅SO₄], N-(2-methacryloyloxy)ethyl-N,N,N-trimethylammonium p-toluenesulphonate [CH₂═C(CH₃) COO—CH₂CH₂—N⁺ (CH₃)₃CH₃C₆H₄ SO₃], N,N,N-triethyl-N-(2-methacryloxyethyl)ammonium chloride [CH₂═C(CH₃) COO—CH₂CH₂—N⁺ (C₂H₅)₃Cl⁻], N,N,N-tripropyl-N-(2-methacryloxyethyl)ammonium chloride [CH₂═C(CH₃) COO—CH₂CH₂—N⁺ (C₃H₇)₃Cl⁻], N,N,N-trimethyl-N-(2-methacryloxypropyl)ammonium chloride [CH₂═C(CH₃) COO—CH₂CH₂CH₂—N⁺ (CH₃)₃Cl⁻] or [CH₂═C(CH₃) COO—CHCH₃CH₂—N⁺ (CH₃)₃Cl⁻], N,N,N-trimethyl-N-(2-methacryloxybutyl)ammonium chloride [CH₂═C(CH₃) COO— (C₄H₈)—N⁺ (CH₃)₃Cl⁻], and N,N,N-triethyl-N-(2-methacryloxybutyl)ammonium chloride [CH₂═C(CH₃) COO—(C₄H₈)—N⁺ (C₂H₅)₃Cl⁻].

Here, particular preference is given to 2-trimethylammonioethyl methacrylate chloride (TMAEMC) of the formula

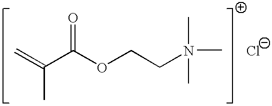

The water-soluble polymer can preferably have from 1% by weight to 15% by weight, preferably from 2% by weight to 8% by weight and particularly preferably from 4% by weight to 6% by weight, of repeating units derived from monomers having at least one quaternary ammonium group, based on the total weight of the water-soluble polymer.

In addition to the repeating units derived from monomers having at least one quaternary ammonium group, the water-soluble polymers to be used according to the invention comprise repeating units derived from ester monomers containing polyoxyalkylene groups. Polyoxyalkylene groups are usually obtained by polymerization of epoxides. Preferred epoxides which can be used for producing polyoxyalkylene groups include, inter alia, ethylene oxide, propylene oxide, butylene oxide, pentylene oxide and hexylene oxide, with ethylene oxide and propylene oxide being particularly preferred. It is possible to use two, three or more different epoxides here, and block copolymers or random polymers can be obtained.

The ester monomer containing polyalkoxyalkylene groups is preferably a compound of the formula (II),

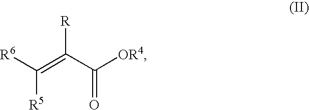

where R is hydrogen or methyl, R⁴ is an alkoxylated radical of the formula (III)

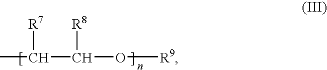

where R⁷ and R⁸ are each, independently of one another, hydrogen or methyl, R⁹ is hydrogen or an alkyl radical having from 1 to 20 carbon atoms and n is an integer from 65 to 230, R⁵ and R⁶ are each, independently of one another, hydrogen or a group of the formula —COOR″″, where R″″ is hydrogen or an alkoxylated radical of the abovementioned formula (III).

(Meth)acrylates having polyalkoxyalkylene groups are of particular interest. These compounds include, in particular, polyethylene glycol mono(meth)acrylate, polypropylene glycol mono(meth)acrylate, polybutylene glycol mono(meth)acrylate, polyethylene glycol-polypropylene glycol mono(meth)acrylate, polyethylene glycol-polybutylene glycol mono(meth)acrylate, poly-propylene glycol-polybutylene glycol mono(meth)-acrylate, polyethylene glycol-polypropylene glycol-polybutylene glycol mono(meth)acrylate, methoxypoly-ethylene glycol (meth)acrylate, methoxypolypropylene glycol (meth)acrylate, methoxypolybutylene glycol (meth)acrylate, methoxypolybutylene glycol (meth)-acrylate, methoxypolyethylene glycol-polypropylene glycol mono(meth)acrylate, methoxypolyethylene glycol-polybutylene glycol (meth)acrylate, methoxypoly-propylene glycol-polybutylene glycol (meth)acrylate, methoxypropylethylene glycol-polypropylene glycol-polybutylene glycol (meth)acrylate, ethoxypolyethylene glycol (meth)acrylate, ethoxypolypropylene glycol (meth)acrylate, ethoxypolybutylene glycol (meth)-acrylate, ethoxypolyethylene glycol-polypropylene glycol (meth)acrylate, ethoxypolyethylene glycol-polybutylene glycol (meth)acrylate, ethoxypolypropylene glycol-polybutylene glycol (meth)acrylate and ethoxy-polyethylene glycol-polypropylene glycol-polybutylene glycol (meth)acrylate. These compounds can be used either individually or as a mixture for preparing the water-soluble polymers. The water-soluble polymer can particularly preferably have repeating units derived from methoxypolyethylene glycol methacrylate.

Ester monomers which contain polyalkoxyalkylene groups and have a number average molecular weight in the range from 4000 g/mol to 6000 g/mol are of particular interest. The number average molecular weight Mₙ can be determined, inter alia, by gel permeation chromatography (GPC).

According to a particular aspect of the present invention, the water-soluble polymer can be prepared using ester monomers which contain polyalkoxyalkylene groups and preferably have a polydispersity index M_{w}/Mₙ in the range from 1.5 to 5.0, particularly preferably in the range from 1.8 to 3.0. The weight average molecular weight M_{w} can be determined, for example, by gel permeation chromatography (GPC).

The water-soluble polymer can preferably have from 50% by weight to 98% by weight, more preferably from 60% by weight to 85% by weight and particularly preferably from 70% by weight to 80% by weight, of repeating units derived from ester monomers containing polyalkoxyalkylene groups, based on the total weight of the water-soluble polymer.

Furthermore, the water-soluble polymer to be used according to the invention has repeating units derived from monomers having at least one carboxy group. Such compounds are widely known to those skilled in the art. Suitable examples encompass, in particular, unsaturated monocarboxylic acids, in particular acrylic acids, methacrylic acids and their monovalent metal salts, divalent metal salts, ammonium salts and organic amino salts, and also unsaturated dicarboxylic acids such as maleic acid, fumaric acid, citraconic acid, etc., or monoesters of these acids with aliphatic alcohols having from 1 to 20 carbon atoms and their monovalent metal salts, divalent metal salts, ammonium salts and organic amino salts. These monomers can be used either individually or as a mixture.

Among these monomers, particular preference is given to methacrylic acid (2-methylpropenoic acid) and the abovementioned salts of methacrylic acid (2-methyl-propenoic acid).

The water-soluble polymer can preferably have from 5% by weight to 30% by weight, more preferably from 10% by weight to 25% by weight and particularly preferably from 15% by weight to 20% by weight, of repeating units derived from monomers having at least one carboxy group, based on the total weight of the water-soluble polymer.

Furthermore, the water-soluble polymer can have repeating units derived from comonomers. Comonomers are monomers which can be copolymerized with the abovementioned monomers.

Examples of suitable compounds which can be used as comonomers encompass esters of aliphatic alcohols having from 1 to 6 carbon atoms with (meth)acrylic acid, diesters of unsaturated dicarboxylic acids such as maleic acid, fumaric acid, citraconic acid, etc., with aliphatic alcohols having from 1 to 20 carbon atoms, unsaturated amides such as (meth)acrylamide and (meth)acrylalkylamide, vinyl esters such as vinyl acetate and vinyl propionate, aromatic vinyls such as styrene, unsaturated sulphonates such as vinyl-sulphonates, (meth)allylsulphonic acid, sulphoethyl (meth)acrylates, 2-(meth)acrylamido-2-methylpropane-sulphonic acid and styrenesulphonates, and their monovalent metal salts, divalent metal salts, ammonium salts and organic amino salts. These compounds can be used either individually or as a mixture.

The water-soluble polymer particularly preferably contains repeating units derived from a (meth)acrylate having from 1 to 6 carbon atoms in the alcohol radical, particularly preferably methyl methacrylate, as comonomer.

The water-soluble polymer can preferably have from 0% by weight to 15% by weight, more preferably from 1% by weight to 10% by weight and particularly preferably from 3% by weight to 6% by weight, of repeating units derived from comonomers, based on the total weight of the water-soluble polymer.

The water-soluble polymer to be used according to the invention can be synthesized using known methods such as solution polymerization or bulk polymerization.

Solution polymerization can be carried out by means of a batch, semicontinuous or continuous process. Solvents which can be used include water, alcohols such as methyl alcohol, ethyl alcohol and isopropyl alcohol, aromatic and aliphatic hydrocarbons such as benzene, toluene, xylene, cyclohexane and n-hexane and ketone compounds such as acetone and methyl ethyl ketone. To achieve solubility of both the monomers and the water-soluble polymer formed, it is advantageous to use at least one solvent selected from the group consisting of water and lower alcohols having from 1 to 4 carbon atoms. Methanol, ethanol and isopropanol are particularly useful alcohols.

If the polymerization is carried out in an aqueous liquid, it is possible to use water-soluble polymerization initiators such as ammonium persulphate, sodium persulphate, hydrogen peroxide and azoamidine compounds such as azobis-2-methylpropionamide hydro-chloride.

Accelerators such as sodium hydrogensulphite can be used together with these initiators. Furthermore, the polymerization can be carried out using a lower alcohol, an aromatic hydrocarbon, an aliphatic hydrocarbon, an ester compound or a ketone compound as solvent and peroxides such as benzoyl peroxide and lauroyl peroxide; hydroperoxides such as cumene hydroperoxide; and azo compounds such as 2,2′-azobis-isobutyronitrile as polymerization initiators. In this case, it is possible to use accelerators such as amino compounds together with the abovementioned initiators. The polymerization temperature can be selected according to the solvent used and the polymerization initiator required. The polymerization is normally carried out in the range from 0° to 120° C.

The proportion of polymerization initiator is preferably in the range from 0.01% by weight to 5% by weight, more preferably in the range from 0.1% by weight to 3% by weight, based on the total weight of the mixture used for preparing the water-soluble polymer.

Bulk polymerization can, for example, be carried out using peroxides such as benzoyl peroxide and lauroyl peroxide, hydroperoxides such as cumene hydroperoxide and aliphatic azo compounds such as 2,2-azobis-isobutyronitrile as polymerization initiator and in the temperature range from 50 to 200° C.

To control the molecular weight, chain transfer agents can also be used in the preparation of the water-soluble polymers.

Preferred chain transfer agents include, for example, mercaptoethanol, thioglycerol, thioglycolic acid, thioglycolic esters, in particular octyl thioglycolate, mercaptomethyl propionate and n-dodecyl mercaptan, with thioglycolic acid and mercaptoethanol being particularly preferred.

The proportion of chain transfer agents is preferably in the range from 0.01% by weight to 5% by weight, more preferably in the range from 0.1% by weight to 3% by weight and particularly preferably in the range from 0.5% by weight to 1.5% by weight, based on the total weight of the mixture used for preparing the water-soluble polymer.

According to a particular aspect of the present invention, preference is given to using a water-soluble polymer which can be obtained by polymerization of a monomer composition comprising

from 1% by weight to 15% by weight, preferably from 2% by weight to 8% by weight and particularly preferably from 4% by weight to 6% by weight, of at least one monomer having at least one quaternary ammonium group in the alcohol radical,
from 50% by weight to 98% by weight, preferably from 60% by weight to 85% by weight and particularly preferably from 70% by weight to 80% by weight, of at least one ester monomer comprising polyalkoxyalkylene groups and having a number average molecular weight in the range from 3000 g/mol to 10 000 g/mol,
from 5% by weight to 30% by weight, preferably from 10% by weight to 25% by weight and particularly preferably from 15% by weight to 20% by weight, of at least one monomer having at least one carboxy group and
from 0% by weight to 15% by weight, preferably from 1% by weight to 10% by weight and particularly preferably from 3% by weight to 6% by weight, of at least one comonomer, in each case based on the total weight of the monomers used.

Water-soluble polymers which preferably have a weight average molecular weight in the range from 5000 g/mol to 100 000 g/mol, particularly preferably from 10 000 to 50 000 g/mol, are of particular interest. The weight-average molecular weight M_{w} can be determined, inter alia, by gel permeation chromatography (GPC).

According to a particular aspect of the present invention, the water-soluble polymer can preferably have a polydispersity index M_{w}/Mₙ in the range from 1.5 to 5.0, particularly preferably in the range from 1.8 to 3.0. The number average molecular weight Mₙ can be determined, for example, by gel permeation chromatography (GPC).

The dispersion preferably comprises from 0.01% by weight to 5% by weight, particularly preferably from 0.02% by weight to 1% by weight, of water-soluble polymer.

An aqueous solution of the water-soluble polymer preferably has a pH in the range from 1.8 to 4.5, particularly preferably in the range from 2.1 to 4.0, with the pH being able to be adjusted by means of customary additives, for example by means of bases, in particular NaOH, KOH, or acids, in particular HCl or H₂SO₄.

Furthermore, the dispersion of the invention can contain customary additives such as cement dispersants, air-entraining agents, cement moisteners, expansion agents, hydrophobicizing agents, retardants, water-soluble polymeric substances, thickeners, coagulants, means of reducing the dry shrinkage, means of increasing the strength and curing accelerators.

The dispersion of the invention can, for example, contain hydraulic cements such as portland cement, high-alumina cement and various mixed cements or hydraulic materials which are different from cement, for example plaster of Paris.

The dispersion of the invention can be used, in particular, for producing concrete. For this purpose, the dispersion can comprise, for example, cement, in particular portland cement, slag residues, sand and gravel.

A dispersion according to the invention surprisingly displays a high flowability which remains constant over a long period of time. Thus, the flowability (slump) of preferred dispersions is at least 150 mm, particularly preferably at least 200 mm and very particularly preferably at least 230 mm, with these values being able to be measured immediately after preparation of the dispersion and two hours after preparation of the dispersion. Accordingly, the ratio of the flowability of the dispersion immediately after it has been prepared and about two hours after it has been prepared is preferably in the range from 1.5:1 to 1:1.5 and very particularly preferably from 1.2:1 to 1:1.2. The flowability (slump) can be measured in accordance with GB/T50080-2002 (Chinese national standard).

Furthermore, inorganic materials which can be obtained from the present dispersion display excellent mechanical properties, in particular a high compressive strength.

The invention is illustrated below with the aid of an example and comparative examples, without this constituting a restriction.

### EXAMPLE 1

300 g of water were firstly placed in a reaction vessel provided with a stirrer, heated to the polymerization temperature of 88° C. and purged by means of nitrogen. 320 g of a monomer mixture comprising 71% by weight of methoxypolyethylene glycol methacrylate (MPEGMA) having a molar mass of about 5000 g/mol, 19% by weight of methacrylic acid (MAA), 5% by weight of methyl methacrylate (MMA) and 5% by weight of trimethyl-ammonioethyl methacrylate chloride (TMAEMC), in each case based on the total weight of the monomers, were introduced into the reaction vessel over a period of 4 hours. The monomer mixture additionally contained 1% by weight of thioglycolic acid, based on the total weight of the monomers. 182 g of an aqueous ammonium persulphate solution (1.62 g of ammonium persulphate=1% by weight based on the total weight of the monomers) were introduced as a separate feedstream over a period of 5 hours.

After all the initiator had been added, the reaction vessel was stirred at 88° C. for another one hour in order to complete the reaction. After cooling the reaction mixture, the pH was set to a value of about 6.7 by means of 50% strength NaOH solution.

The properties of the water-soluble polymer obtained in this way were subsequently examined in a dispersion. For this purpose, a mixture comprising 170 parts by weight of water, 400 parts by weight of cement (Lianhe PO 42.5), 70 parts by weight of slag residues, 740 parts by weight of sand, 1030 parts by weight of gravel and 1.0 part by weight of water-soluble polymer was prepared.

The dispersion had a flowability of about 245 mm immediately after it had been prepared, about 265 mm one hour after it had been prepared and about 245 mm two hours after it had been prepared.

After curing for 28 days, the dispersion gave a concrete which had a compressive strength in accordance with GB 8076-1997 (Chinese national standard) of 75.7 MPa.

### COMPARATIVE EXAMPLE 1

Example 1 was repeated using a methoxypolyethylene glycol methacrylate (MPEGMA) having a molar mass of about 2000 g/mol for preparing the water-soluble polymer.

The dispersion had a flowability of about 265 mm immediately after it had been prepared, about 245 mm one hour after it had been prepared and about 210 mm two hours after it had been prepared.

### COMPARATIVE EXAMPLE 2

Example 1 was repeated using dimethylaminoethyl methacrylate (DMAEMA) instead of trimethylammonioethyl methacrylate chloride (TMAEMC) for preparing the water-soluble polymer.

The dispersion had a flowability of about 255 mm immediately after it had been prepared, about 270 mm one hour after it had been prepared and about 195 mm two hours after it had been prepared.

1. A dispersion comprising inorganic particles, water and at least one water-soluble polymer, wherein the water-soluble polymer comprises a repeating unit derived from a monomer having at least one quaternary ammonium group, a repeating unit derived from a monomer having at least one carboxy group and a repeating unit derived from an ester monomer which comprises a polyalkoxyalkylene group and has a molecular weight in the range from 3000 g/mol to 10 000 g/mol.

2. The dispersion according to claim 1, wherein the monomer having a quaternary ammonium group is a compound of formula (I) 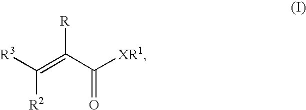
where R is hydrogen or methyl, X is oxygen or a group of the formula —NR*, where R* is hydrogen or an alkyl group having from 1 to 4 carbon atoms, R¹ is a group which has from 4 to 30 carbon atoms and has at least one quaternary ammonium group, R² and R³ are each, independently of one another, hydrogen or a group of the formula —COOR′, where R′ is hydrogen or a group which has from 4 to 30 carbon atoms and has at least one quaternary ammonium group.

3. The dispersion according to claim 2, wherein the monomer having a quaternary ammonium group is a (meth)acrylate or a (meth)acrylamide.

4. The dispersion according to claim 3, wherein the (meth)acrylate having a quaternary ammonium group is 2-trimethylammonioethyl methacrylate chloride (TMAEMC).

5. The dispersion according to claim 1, wherein the ester monomer comprising polyalkoxyalkylene groups is a compound of the formula (II), 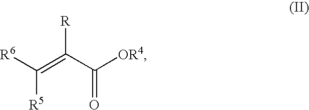
where R is hydrogen or methyl, R⁴ is an alkoxylated radical of the formula (III) 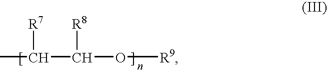
where R⁷ and R⁸ are each, independently of one another, hydrogen or methyl, R⁹ is hydrogen or an alkyl radical having from 1 to 20 carbon atoms and n is an integer from 65 to 230, R⁵ and R⁶ are each, independently of one another, hydrogen or a group of the formula —COOR″″, where R″″ is hydrogen or an alkoxylated radical of the abovementioned formula (III).

6. The dispersion according to claim 5, wherein the ester monomer comprising polyalkoxyalkylene groups is a (meth)acrylate.

7. The dispersion according to claim 6, wherein the (meth)acrylate comprising polyalkoxyalkylene groups is a methoxypolyethylene glycol methacrylate.

8. The dispersion according to claim 1, wherein the ester monomer comprising polyalkoxyalkylene groups has a number average molecular weight in the range from 4000 g/mol to 6000 g/mol.

9. The dispersion according to claim 1, wherein the ester monomer comprising polyalkoxyalkylene groups has a polydispersity index M_{w}/Mₙ, in the range from 1.5 to 5.0.

10. The dispersion according to claim 1, wherein the monomer having at least one carboxy group is methacrylic acid.

11. The dispersion according to claim 1, wherein the water-soluble polymer comprises a repeating unit derived from a comonomer.

12. The dispersion according to claim 11, wherein the comonomer is a (meth)acrylate having from 1 to 6 carbon atoms in the alcohol radical.

13. The dispersion according to claim 12, wherein the comonomer is methyl methacrylate.

14. The dispersion according to claim 1, wherein the water-soluble polymer has a weight average molecular weight in the range from 5000 to 100 000 g/mol.

15. The dispersion according to claim 1, wherein the water-soluble polymer has a polydispersity index KIM, in the range from 1.5 to 5.0.

16. The dispersion according to claim 1, wherein the water-soluble polymer is obtained by polymerization of a monomer composition comprising
from 2% by weight to 8% by weight of at least one monomer having at least one quaternary ammonium group,
from 60% by weight to 85% by weight of at least one ester monomer comprising polyalkoxyalkylene groups and having a number average molecular weight in the range from 3000 g/mol to 10 000 g/mol,
from 10% by weight to 20% by weight of at least one monomer having a carboxy group and
from 0% by weight to 15% by weight of at least one comonomer, based on the total weight of the monomers used.

17. The dispersion according to claim 1, wherein the dispersion comprises from 1% by weight to 30% by weight of water.

18. The dispersion according to claim 1, wherein the dispersion comprises from 70% by weight to 98.99% by weight of inorganic particles.

19. The dispersion according to claim 1, wherein the dispersion comprises from 0.01% by weight to 5% by weight of water-soluble polymer.

20-22. (canceled)

23. A process for obtaining concrete, comprising dispersing inorganic particles, water and said at least one water-soluble polymer according to claim 1.

24. The process according to claim 23, wherein a water-soluble polymer comprises repeating units derived from monomers having at least one quaternary ammonium group, repeating units derived from monomers having at least one carboxy group and repeating units derived from ester monomers which contain polyalkoxyalkylene groups and have a number average molecular weight in the range from 3000 g/mol to 10 000 g/mol for increasing the processing time of a dispersion for producing concrete
